(19) United States
(12) Patent Application Publication
(10) Pub. No.: US 2003/0060742 A1
(43) Pub. Date: Mar. 27, 2003

(54) Brain-shaped portable vibrator

(75) Inventors: Seung-Hun Lee, Chungbuk (KR); Kun Ho Lee, Seoul (KR); Yong Seok Choi, Kyunggi-do (KR)

Correspondence Address: Jay F. Moldovanyi, Suite 700, 1100 Superior Ave., Cleveland, OH, 44114-2518, US

(73) Assignee: The Korean Research Institute for New Human Science

(21) Appl. No.: 09/941,805

(22) Filed: Aug. 29, 2001

(51) Int. Cl. A61H 1/00

(52) U.S. Cl. 601/70

(57) ABSTRACT

A portable vibrator for relaxation and meditation according to the present invention is characterized by having an internal vibrator including a vibration motor, a power source, a one-touch switch for turning on or off the vibration motor, and an outer cover elastic enough to operating the switch, shaped of brain, and covering the internal vibrator to a sealed state. According to a structure of the power source, the portable vibrator is classified into a charging type and a dry cell type.

### FIELD OF THE INVENTION

The present invention relates to a vibrator for relaxation and meditation which performs regular vibrations. More specifically, the present invention relates to a brain-shaped portable vibrator for relaxation and meditation in which if a one-touch switch is pressed, the vibrator can be turned on and off, and the regular vibrations alleviates the body strains and promotes the blood circulations.

### BACKGROUND OF THE INVENTION

In the conventional acupressure apparatuses or massaging apparatuses for relaxation and meditation, the vibrations cause the body relaxation, and they have a considerably large bulk.

In a treading type vibrator, a vibration motor and a vibration shaft are disposed under a treading plate. In a whole body vibrator, a vibration motor and a vibration shaft are disposed within a facility such as a large chair or the like. Therefore, they are not portable, and particularly, if a massaging effect is to be given to the local portions, the vibrators are not effective at all. Further, the large vibrators produce strong vibrations, and therefore, they are not suitable for calm speculations and meditations, or for the energizing practices. Accordingly, a demand has been felt for an apparatus for producing quiet regular vibrations to give gradual massaging effect. Particularly a vibrator has been demanded which is suitable for meditations and energizing practices.

The present inventor has developed a charging type brain-shaped vibrator under Korean Patent Application No. 2001-36204. The present invention is an improvement of it. That is, a battery housing is provided so that a conventional dry cell battery can be used.

### OBJECTS OF THE INVENTION

It is an object of the present invention to provide a portable vibrator for relaxation and meditation in which regular vibrations are directly felt by the human body, so as to make it possible to alleviate body strain and to promote blood circulations.

It is another object of the present invention to provide a portable vibrator in which regular vibrations are directly felt by human body, so as to make it possible to help brain respiration and meditations.

It is still another object of the present invention to provide a portable vibrator in which regular vibrations are directly felt by human body, so as to make it possible to alleviate any local pains.

It is still another object of the present invention to provide a portable vibrator in which regular vibrations are directly felt by human body, so as to make it possible to improve memorizing ability and concentrating ability.

It is still another object of the present invention to provide a portable vibrator in which regular vibrations are directly felt by human body, so as to make it possible to eliminate mental instability and anxiousness.

It is still another object of the present invention to provide a portable vibrator in which turning-on and -off are possible while holding the vibrator with one hand.

It is still another object of the present invention to provide a portable brain-shaped vibrator in which mental concentration is improved.

It is still another object of the present invention to provide a portable vibrator in which conventional dry cell batteries can be used.

It is still another object of the present invention to provide a portable charging type vibrator which can be used almost permanently.

The above objects and other objects can be achieved by the present invention as described below.

### SUMMARY OF THE INVENTION

In achieving the above objects, a portable vibrator for relaxation and meditation according to the present invention is characterized by having an internal vibrator including a vibration motor, a power source, a one-touch switch for turning on or off the vibration motor, and an outer cover elastic enough to operating the switch, shaped of brain, and covering the internal vibrator to a sealed state. According to a structure of the power source, the portable vibrator is classified into a charging type and a dry cell type.

A charging type vibrator has an internal vibrator including a vibration motor, a charging battery connected to a charging terminal block for activating the motor, and a one-touch on-off switch of the vibration motor, an upper cover for covering the internal vibrator to a sealed state and which is made of foamed urethane and a lower cover having a hole for exposing the charging terminal block to the outside and formed by foaming to be attached to the upper cover.

A dry cell type vibrator has an internal vibrator including a vibration motor, a dry cell battery for activating the motor, and a one-touch on-off switch of the vibration motor, an outer cover covering the internal vibrator to a sealed state and made of a soft material, and an opening lid formed at one part of the outer cover and made of a soft material

### BRIEF DESCRIPTION OF THE DRAWINGS

The above object and other advantages of the present invention will become more apparent by describing in detail the preferred embodiment of the present invention with reference to the attached drawings in which:

FIG. 1 is a perspective view of the brain-shaped portable vibrator according to the present invention;

FIG. 2 is an exploded perspective view of the brain-shaped portable vibrator of the present invention, which includes an upper cover, an internal vibrator and a lower cover;

FIG. 3 is a bottom view of the upper cover of the brain-shaped portable vibrator in which the power supply part is of a charging type;

FIG. 4A is a sectional view taken along a line A-A of FIG. 2; FIG. 4B is a sectional view taken along a line B-B of FIG. 2; and FIG. 4C is a bottom view of the internal vibrator;

FIG. 5A is a sectional view showing a state in which the opening lid is open in a brain-shaped portable vibrator of a sliding type; and FIG. 5B is an enlarged perspective view showing the coupling between the opening lid and an outer cover;

FIG. 6A is a sectional view showing an open state of the door type lid of the brain-shaped portable vibrator; and FIG. 6B is an enlarged perspective view showing the coupling between the opening lid and the outer cover; and

FIG. 7A illustrates the circuit of the portable vibrator according to the present invention; and FIG. 7B is a detailed circuit diagram in which a constant voltage circuit is added to the power supply part.

### DETAILED DESCRIPTION OF THE INVENTION

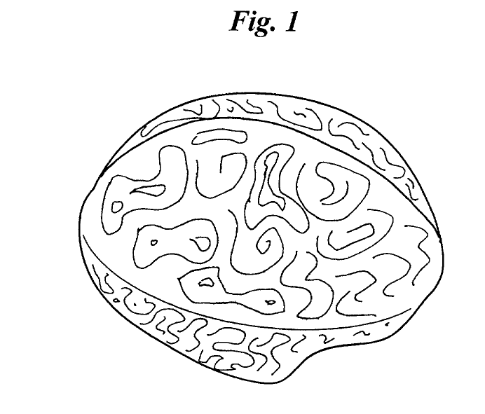

FIG. 1 is a perspective view of the brain-shaped portable vibrator for relaxation and meditation according to the present invention. Its external shape is like a human brain, and its size is such that an adult can hold it with one hand.

Since the external shape of the vibrator is like a human brain, an association to the brain is realized to enhance mental concentration, so that energizing practice, brain respiration and meditations can be facilitated. Further, the outside surface of the vibrator has furrows like the human brain, and therefore, when using it, the association and mental focus can be doubled. However, the external shape of the vibrator is not necessarily limited to the shape of the human brain, but if it can be held with one hand, it should come within the scope of the present invention. Further, the cover of the vibrator of the present invention is made of a soft material such as foamed urethane, silicon or a soft plastic, and therefore, soft touch feeling is doubled.

The brain-shaped portable vibrator according to the present invention can be either of a charging type or a dry cell type. These two types will be respectively described below.

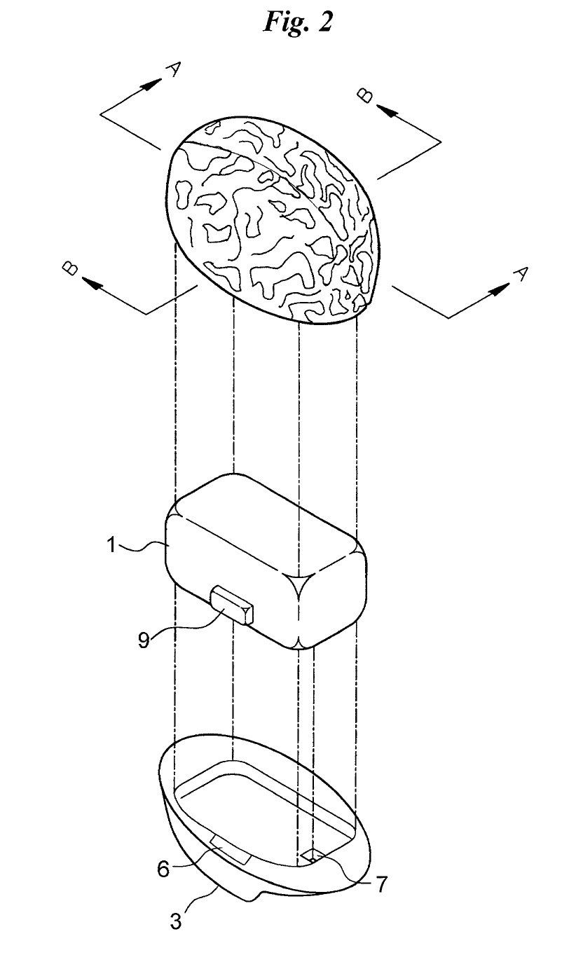

FIG. 2 is an exploded perspective view of the brain-shaped portable vibrator of the present invention, which includes an upper cover 2, an internal vibrator 1 and a lower cover 3. A one-touch type switch 4 is formed on one part of the internal vibrator, and therefore, by one touch pressing, a motor 10 of the internal vibrator can be driven. If the switch is pressed once more, the vibration motor 10 is stopped. Such a switch can be easily understood by those ordinarily skilled in the art.

An adhesive member 9 is disposed on the portion where the switch and the cover contact to each other, the adhesive member being secured to the end of the switch. Thus, the brain-shaped vibrator of the present invention can be easily held with one hand, and easily switched with one hand. That is, the switch activating area is not limited to a narrow area, but extends to a wide area, and therefore, the one-hand switching of the vibrator is further facilitated. In the drawing, the internal vibrator 1 is parallelepiped, but is not limited to this shape. That is, it can be of an inclined type or it can be of an egg shape, so that the vibrator can be made stable.

The upper and lower covers are made of a foamed polyurethane, so that soft touch feeling can be enhanced when grasped it. Further, a waterproof effect can also be achieved. After inserting the internal vibrator into the upper cover, the lower cover is attached to them by carrying out a foam forming, thereby solving the attaching problem for the three components 1, 2 and 3. Further, a foaming moisture intrusion preventing member 6 is formed on the portion where the switch contacts. Thus, the switch is protected from a malfunction due to the moisture intrusion. Further, the lower cover is provided with a hole 7 for exposing a charging terminal 8.

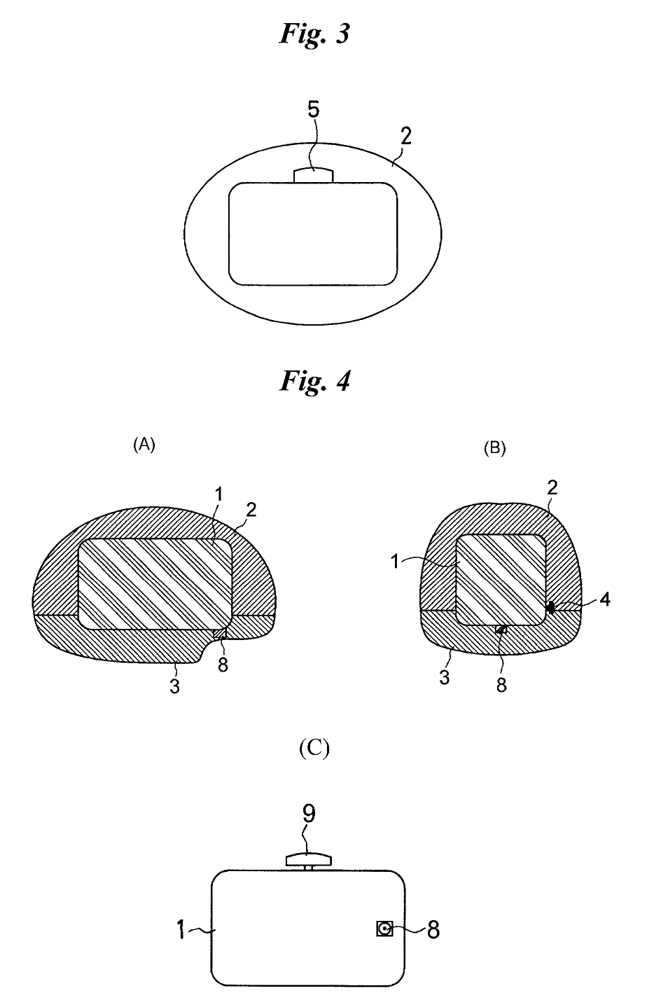

FIG. 3 is a bottom view of the upper cover of the brain-shaped portable vibrator in which the power supply part is of a charging type. The upper cover covers the internal vibrator to a sealed state. The inside surface of the upper cover is made to be suitable for the internal vibrator, and these two members are coupled together in a perfectly fitting form. This is for transmitting the vibrations to the outside in a perfect manner, when the vibrator is activated.

Further, there is formed a switch accommodating part 5 which is large enough to accommodate the one-touch on-off switch. Thus, as long as the user does not activate the vibrator, any activation of the switch due to the pressure of the upper cover can be prevented.

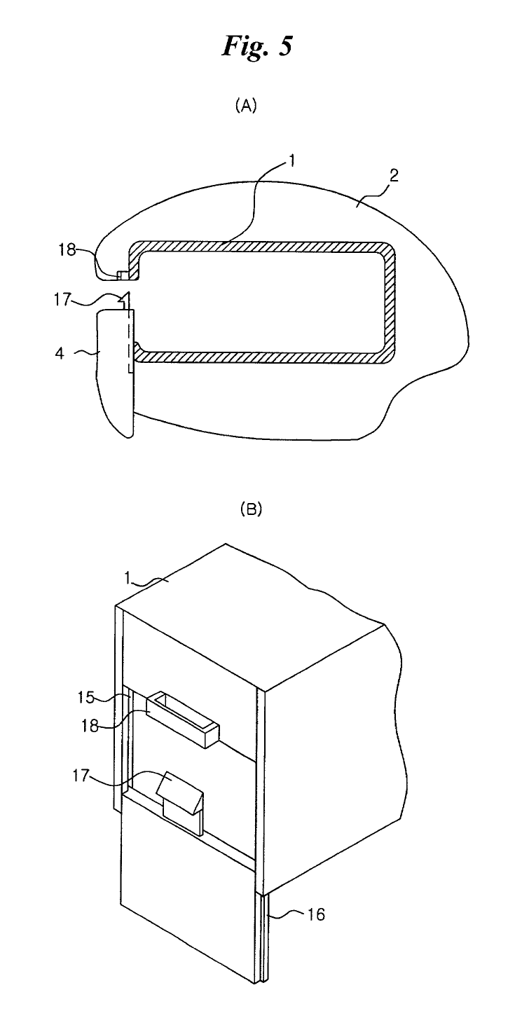

FIG. 4A is a sectional view taken along a line A-A of FIG. 2, FIG. 4B is a sectional view taken along a line B-B of FIG. 2, and FIG. 4C is a bottom view of the internal vibrator. A charging terminal block 8 is formed on the lower portion of the internal vibrator, so that the terminal block can be inserted into a charging jack (not illustrated). The charging terminal block is exposed to the outside through a hole 7 of the lower cover. When a charging battery which has been accommodated within the internal vibrator is exhausted, the battery can be recharged, so that the brain-shaped portable vibrator of the present invention can be continuously used. Therefore, the brain-shaped vibrator according to the present invention can be used almost permanently, and also can be carried with in a convenient manner.

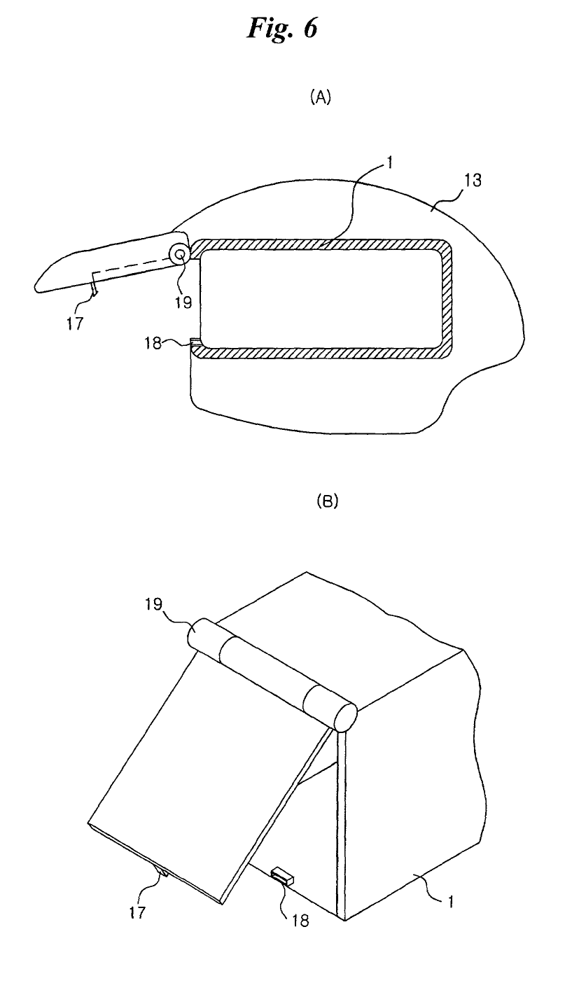

FIG. 5A is a sectional view showing a state in which the opening lid is open in a brain-shaped portable vibrator of a sliding type, and FIG. 5B is an enlarged perspective view showing the coupling between the opening lid and an outer cover.

In another embodiment, the dry cell type portable vibrator according to the present invention includes an internal vibrator 1, an outer cover 13 and an opening lid 14.

In the charging type vibrator, the upper and lower covers 2 and 3 are made of a foamed polyurethane. That is, the internal vibrator is inserted into the upper cover, and the lower cover is foaming-attached to the structure, thereby solving the attaching problem. On the other hand, in the dry cell type vibrator, the whole structure is formed at one time by a molding process in a state with an outer cover 13 being open. The open portion is for fitting the opening lid 14.

That is, an upper molding die and a lower molding die are used to mold the outer cover. If silicon is used, an extrusion forming is employed, while if a soft plastic material is used, an injection molding method is adopted. After forming the outer cover, the internal vibrator is inserted into the outer cover through the open portion to which the opening lid is to be fitted. Even if the open portion for the opening lid is narrower compared with the internal vibrator, it can be sufficiently inserted owing to the flexibility of silicon or soft plastic material. Preferably, the internal vibrator is attached into the outer cover by using an adhesive, so that any gap between the outer cover and the internal vibrator can be removed.

Preferably, a light emitting diode (not illustrated) is added to the top of the internal vibrator, so that the light emitting diode can be lighted upon turning on the vibrator of the present invention. The outer cover is made of a translucent or transparent silicon or soft plastic, so that the light emitting diode can be lighted upon turning on the vibrator, thereby making it possible to visually confirm the activation of the vibrator.

Further, the open portion has a hole for inserting or taking out the dry cells, and the opening lid 14 is fitted to the open portion. In this embodiment, the replacing type dry cells are used, and therefore, a sliding type device or a door type device is formed to take in and out the dry cells.

In the case of the sliding type device, a sliding type lid is pulled down along the side of the outer cover, so that the dry cells can be taken in and out. In the case where two dry cells are inserted, a connecting conductor (not illustrated) is formed on the opening lid, so that the poles of the dry cells are electrically connected together upon closing the opening lid.

FIG. 5B is an enlarged perspective view showing the coupling between the opening and closing lid and an outer cover. On the sidewall of the internal vibrator, there are formed guide grooves 15, while on the side edges of the opening lid, there are formed elongate protrusions 16. Thus the guide grooves 15 and the elongate protrusions 16 are engaged together respectively, so that the opening lid can be moved up and down. Preferably a stopping step is formed at each of the ends of the guide grooves of the internal vibrator, so that the sliding type lid cannot depart from the internal vibrator. More preferably the elongate protrusions are formed only on the upper portion of the sliding type lid, and protuberances are formed on the end of the hole of the internal vibrator. Thus the sliding type lid can be prevented from departing from the outer cover.

Further, an engaging frame 18 is formed on the internal vibrator, and an engaging hook 17 is formed on the sliding type lid, so that the engaging hook can be engaged to the engaging frame. Alternatively, the guide grooves are formed on the outer cover instead of the internal vibrator, so that the opening lid can be directly coupled to the outer cover.

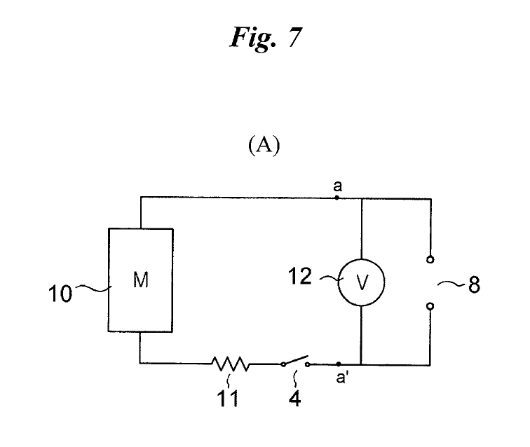

FIG. 6A is a sectional view showing an open state of the door type lid of the brain-shaped portable vibrator. This embodiment includes a door type lid. In this case, a door type lid 14 can be open by pivoting out around a hinge 19, so that the dry cells can be taken in and out. That is, the hinge 19 is installed between the top of the lid 14 and the outer cover, so that the lid 14 can be pivoted in opening it. In the case where two dry cells are used, a conductor (not illustrated) is attached to the opening lid 14 in such a manner that the poles of the dry cells can be electrically connected together upon closing the lid 14, thereby making it possible to drive the vibrating motor.

FIG. 6B is an enlarged perspective view showing the coupling between the opening lid and the outer cover. The most parts of the structure are same as those of the sliding type lid, except that the lid is open by being pivoted around the hinge 19. One side of the hinge is secured to the internal vibrator, and the other side of the hinge is secured to the lid 14, so that the lid can be pivoted around the shaft of the hinge, thereby opening the door type lid. Preferably an engaging frame 18 is formed on the lid, and an engaging hook 17 is formed on the outer cover 13, so that the engaging frame and the engaging hook can be engaged together, thereby making it possible to firmly close the lid. Alternatively, the hinge can be secured on the outer cover instead of the internal vibrator, so that the opening and closing lid can be directly coupled to the outer cover.

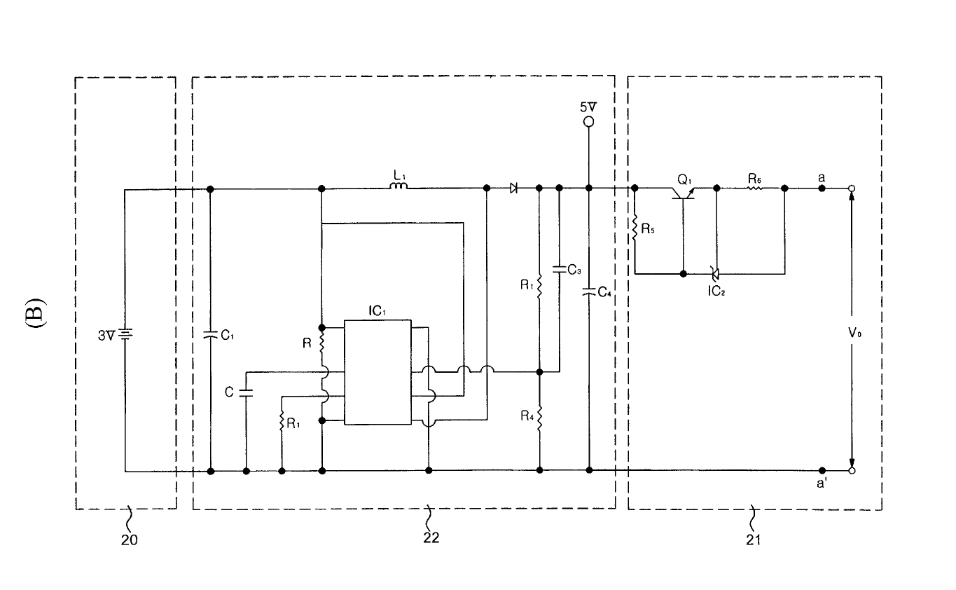

FIG. 7A illustrates the circuit of the portable vibrator according to the present invention. FIG. 7B is a detailed circuit diagram in which a constant voltage circuit is added to the power supply part. Basically, two dry cells of 1.5V are connected to the vibrating motor in series, but the number of the dry cells and the total voltages can be properly varied. Further in the case where the charging type is adopted, rechargeable batteries are used instead of dry cells.

The vibrating motor is an eccentric motor so that vibrations can be produced during revolution. The revolution speed of the eccentric motor can be selected in accordance with the need, but usually, 6000˜8000 rpm will be sufficient. If needed, a resistor 11 can be connected between the vibrating motor and the switch in series, so that the vibrations can be damped. The resistor should be proper one, and preferably, in the case of a motor with 6000˜8000 rpm, a resistance of 4.7 Ω will be proper. The charging terminal is required only in the case of the charging type, while in the case of the dry cell type vibrator, the charging terminal is not required.

FIG. 7B is a detailed circuit diagram in which a constant voltage circuit is added to the power supply part of FIG. 7A. That is, FIG. 7B illustrates the a-a′ segment of FIG. 7A. The voltage of an inputting part 20 including the dry cells is stepped up by a step-up part 22, and the stepped-up voltage is maintained at a constant level by a constant voltage circuit of the step-up part 22. This voltage is stepped down to a required level by an outputting part 21, and is outputted with a level of V₀.

For example, when an input voltage 3.0V passes through the step-up part 22, the voltage is stepped up to 5.0V. Further, when the voltage passes through the outputting part, the voltage is stepped down to 2.0V, so that the output voltage can be maintained at 2.0V. Thus regardless of the status of the vibrating motor, a constant voltage difference is maintained by the constant voltage circuit, and therefore the vibrations of the portable vibrator can be maintained at a constant level.

The step-up part, the step-down part and the constant voltage circuit can be carried out by those ordinarily skilled in the art. The light emitting diode that is installed on the top of the internal vibrator of the portable vibrator can be connected in parallel with the power supply part.

In the above, the present invention was described based on the specific preferred embodiments and the attached drawings, but it should be apparent to those ordinarily skilled in the art that various changes and modifications can be added without departing from the spirit and scope of the present invention, which will be defined in the appended claims.

What is claimed is:

1. A portable vibrator for relaxation and meditation comprising:
an internal vibrator including a vibration motor, a charging battery connected to a charging terminal block for activating the vibration motor, and a one-touch on-off switch of the vibration motor;
an upper cover for covering the internal vibrator to a sealed state and which is made of foamed polyurethane; and
a lower cover having a hole for exposing the charging terminal block to the outside and formed by foaming to be attached to the upper cover;
wherein the internal vibrator is covered to a sealed state by the upper cover and the lower cover.

2. The portable vibrator in claim 1, wherein said vibration motor is activated by pressing a part of the upper cover and the activated motor is stopped by pressing the part again with the one-touch switch situated inside the upper cover in one hand.

3. The portable vibrator in claim 1, wherein said upper cover and said lower cover have brain-shaped surfaces.

4. The portable vibrator in claim 1, wherein said vibration motor is an eccentric motor with about 6,000˜8,000 rpm.

5. A portable vibrator for relaxation and meditation comprising:
an internal vibrator including a vibration motor, dry cells for activating the vibration motor, and a one-touch on-off switch of the vibration motor;
an outer cover for covering the internal vibrator to a sealed state, which is made of a soft material; and
an opening lid formed at one part of the outer cover and made of a soft material;
wherein the internal vibrator is covered to a sealed state by the upper cover and the lower cover.

6. The portable vibrator in claim 5, wherein said soft material is silicon or a soft plastic material.

7. The portable vibrator in claim 5, wherein said vibration motor is activated by pressing a part of the upper cover and the activated motor is stopped by pressing the part again with the one-touch switch situated inside the upper cover in one hand.

8. The portable vibrator in claim 5, wherein said upper cover and said lower cover have brain-shaped surfaces.

9. The portable vibrator in claim 5, wherein said vibration motor is an eccentric motor with about 6,000˜8,000 rpm.

10. The portable vibrator in claim 5, wherein said soft material is translucent or transparent.

11. The portable vibrator in claim 10 further comprising a light emitting diode that is installed at the top of the internal vibrator, being activated with the vibration motor.

12. The portable vibrator in claim 5, wherein said internal vibrator includes a constant voltage circuit for maintaining the voltage of the vibration motor constantly.
